(19) United States
(12) Patent Application Publication
(10) Pub. No.: US 2017/0344738 A1
(43) Pub. Date: Nov. 30, 2017

(54) ELECTRONIC DEVICE AND UNLOCKING METHOD THEREOF

(71) Applicants: Fu Tai Hua Industry (Shenzhen) Co., Ltd., Shenzhen (CN); HON HAI PRECISION INDUSTRY CO., LTD., New Taipei (TW)

(72) Inventor: PENG-BO WANG, Shenzhen (CN)

(21) Appl. No.: 15/212,294

(22) Filed: Jul. 18, 2016

(30) Foreign Application Priority Data
May 27, 2016 (CN) 201610370570.9

(51) Int. Cl. G06F 21/35; H04W 12/06; H04L 29/06

(52) U.S. Cl. CPC G06F 21/35; H04L 63/0853; H04W 12/06

(57) ABSTRACT

In method for unlocking an electronic device, a connection between an electronic device and a separate locking device is established. Identity information of the electronic device is obtained by reference to an identity card in the electronic device. The identity information is stored in a storage device of the electronic device. When the identity card of the electronic device is determined to have been changed, the electronic device is locked. A determination as to a new identity card being arranged in the electronic device can be made. Identity information of the new identity card is read and determined as being the same or not the same as the identity information stored in the storage device. When the read identity information is same as the identity information stored in the storage device, the new identity card is validated and the electronic device is then unlocked.

### CROSS-REFERENCE TO RELATED APPLICATIONS

This application claims priority to Chinese Patent Application No. 201610370570.9 filed on May 27, 2016, the contents of which are incorporated by reference herein.

### FIELD

The subject matter herein generally relates to data security in electronic devices, and more specifically relates to, an electronic device and an unlocking method thereof.

### BACKGROUND

Mobile devices generally include important and private information. Thereby, the mobile devices employ at least one lock method for protecting the important and private information from being disclosed, for example, fingerprint lock, gesture lock, or password lock.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of a hardware environment for executing an unlocking system applied in relation to an electronic device.

FIG. 2 is a block diagram of one embodiment of function modules of the unlocking system.

FIG. 3 is a flowchart of one embodiment of an unlocking method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series, and the like.

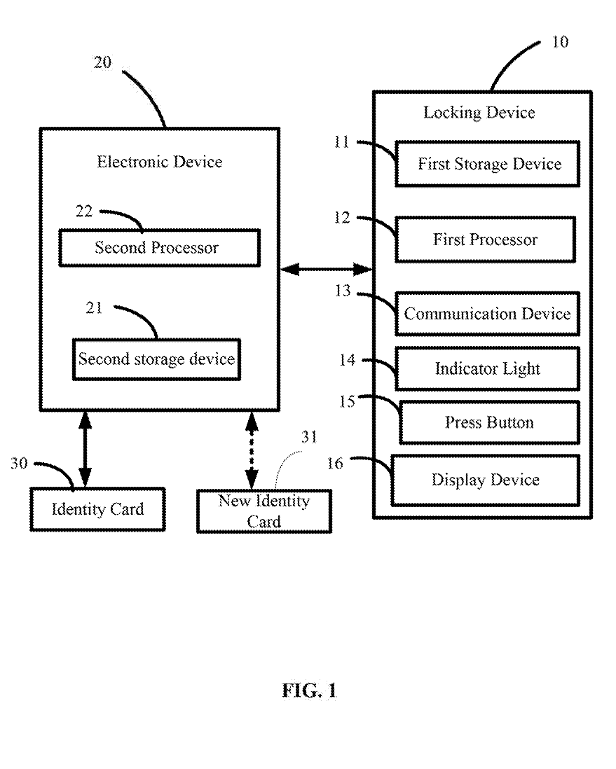

FIG. 1 illustrates a hardware environment for executing an unlocking system in accordance with an embodiment. The unlocking system 100 is installed and runs in the hardware environment including a locking device 10 and an electronic device 20. For example, the electronic device 20 is a smart phone. In other embodiment, the electronic device 20 can be a tablet computer, a notebook computer, a personal digital assistant (PDA), or other suitable electronic device. In a second embodiment, the unlocking system 100 can only be installed and run in the electronic device 20.

In at least one embodiment, as shown in FIG. 1, the locking device 10 includes, but is not limited to, a first storage device 11, a first processor 12, and a communication device 13. The electronic device 20 includes, but is not limited to, a second storage device 21 and a second processor 22. The first storage device 11 includes data or program codes that can be executed by the first processor 12 to perform some functions of the unlocking system 100. The second storage device 21 includes data or program codes that can be executed by the second processor 22 to perform some functions of the unlocking system 100. That is, all functions of the unlocking system 100 are performed by the first processor 12 in cooperating with the second processor 22. The locking device 10 can communicate with the electronic device 20 via the communication device 13. The communication device 13 can be a wireless communication device such a WIFI device or a BLUETOOTH device. In other embodiment, the locking device 10 can connect and communicate with the electronic device 20 via a universal serial bus (USB) connection. FIG. 1 only illustrates one example of the locking device 10 and the electronic device 20; other examples can include more or fewer components than illustrated, or have a different configuration of the various components in other embodiments.

In at least one embodiment, the first storage device 11 and the second storage device 21 can include various types of non-transitory computer-readable storage mediums. For example, the first storage device 11 and the second storage device 21 can be an internal storage system, such as a flash memory, a random access memory (RAM) for temporary storage of information, and/or a read-only memory (ROM) for permanent storage of information. The first storage device 11 and the second storage device 21 can also be an external storage system, such as a hard disk, a storage card, or a data storage medium. The first processor 12 and the second processor 22 can be a central processing unit (CPU), a microprocessor, or other data processor chip that performs functions of the unlocking system 100 in the electronic device 20.

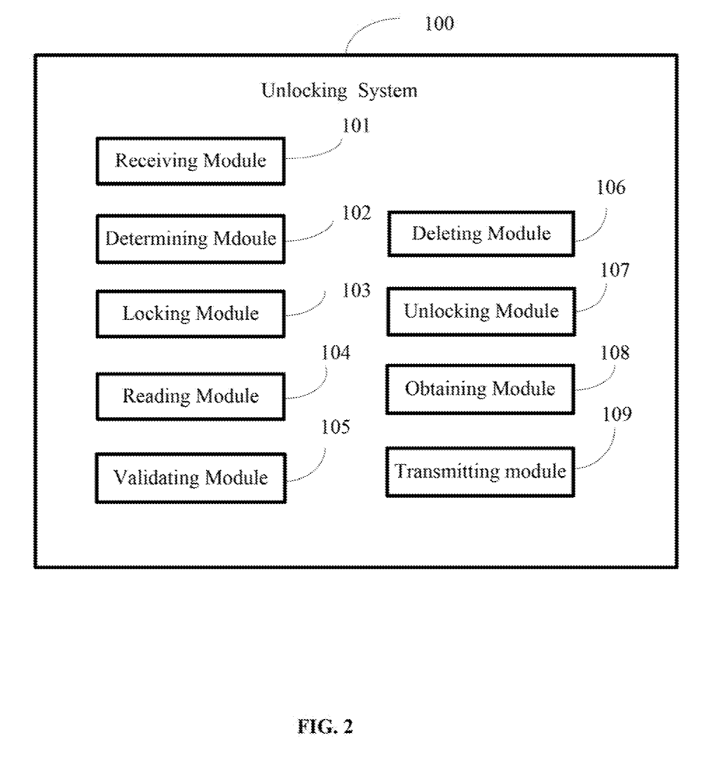

FIG. 2 illustrates function modules of the unlocking system 100. In at least one embodiment, the unlocking system 100 includes a receiving module 101, a determining module 102, a locking module 103, a reading module 104, a validating module 105, a deleting module 106, and an unlocking module 107. The receiving module 101, the determining module 102, the locking module 103, the reading module 104, the validating module 105, the deleting module 106, and the unlocking module 107 are run in the electronic device 20 and are controlled by the second processor 22.

The unlocking system 100 also includes an obtaining module 108 and a transmitting module 109. In the embodiment, the obtaining module 108 and the transmitting module 109 are run in the locking device 10 and controlled by the first processor 12. The function modules 101-109 can include computerized codes in the form of one or more programs, which are stored in the first storage device 11 or the second storage device 21. The first processor 12 executes the computerized codes stored in the first storage device 11 to provide functions of the function modules 108-109. The second processor 22 executes the computerized codes stored in the second storage device 21 to provide functions of the function modules 101-107.

The communication device 13 can establish communication between the electronic device 20 and the locking device 10.

After the locking device 10 is connected to the electronic device 20, the obtaining module 108 can obtain identity information of the electronic device 20. The transmission module 109 can transmit the identity information obtained by the obtaining module 108 to the electronic device 20.

The electronic device 20 can include an identity card 30. The identity card 30 can be arranged in or removed from the electronic device 20. The identity information of the electronic device 20 is associated with identification information within the identity card 30 arranged in the electronic device 20. In an embodiment, the electronic device 20 is a mobile phone. The identity card is a SIM card of the mobile phone. The identity information comprises several types of information, consisting of a card number, a telephone number, communication data, and PIN unlocking key.

In the embodiment, the obtaining module 108 can generate a signal and the transmitting module 109 transmits the signal to the electronic device 20. When the electronic device 20 receives the signal, the reading module 104 can read the identification information of the identity card 30 arranged in the electronic device 20. Then, the obtaining module 108 obtains the identity information of the electronic device 20 from the reading module 104. That is, the obtaining module 108 regards the identification information of the identity card 30 as the identity information of the electronic device 20.

The receiving module 101 can receive the identity information of the electronic device 20 transmitted from the locking device 10. The receiving module 101 further stores the identity information received from the locking device 10 in the second storage device 21.

In one embodiment, before the receiving module 101 stores the identity information in the second storage device 21, the determining module 102 can determine whether there is an identity information pre-stored in the second storage device 21 of the electronic device 20. When there is an identity information pre-stored in the storage device 21, the determining module 102 can further determine whether received identity information is same as the pre-stored identity information. When the received identity information is not same as the pre-stored identity information, the deleting module 106 can delete the pre-stored identity information. The receiving module 101 then stores the received identity information into the second storage device 21.

The determining module 102 can determine whether the identity card 30 arranged in the electronic device 20 has been changed. In the embodiment, the determining module 102 determines whether the reading module 104 can immediately read identity information from the electronic device 20. When the reading module 104 can immediately read identity information from the electronic device 20, that is, the read information from the electronic device 20 is same as the identity information of the identity card 30 originally arranged in the electronic device 20. When the reading module 104 does not read the identity information from the electronic device 20 for a predefined time, such as 10 seconds, the identity card 30 originally arranged in the electronic device 20 can at that moment be removed from the electronic device 20, and be replaced by a new identity card 31. So, when the reading module 104 does not immediately read the identity information from the electronic device 20, the determining module 102 determines that the identity card of the electronic device 20 is changed.

When the identity card of the electronic device 20 is changed, the locking module 103 can lock the electronic device 20. Thereby, no user can obtain information stored in the electronic device 20.

The determining module 102 can further determine whether a new identity card 31 is arranged in the electronic device 20. When a new identity card 31 is determined to be arranged in the electronic device 20, the reading module 104 can read identification information of the new identity card 31.

The determining module 102 further determines whether the read identification information of the new identity card 31 is same as the identity information stored in the second storage device 21. If the new identity card 31 arranged in the electronic device 20 has the same identification information as the identity card 30 originally arranged in the electronic device 20 (according to the stored information), the validating module 105 can validate the new identity card 31 arranged in the electronic device 20, and the unlocking module 107 can unlock the electronic device 20.

In other embodiment, when the read identification information of the new identity card 31 is not same as the stored identity information, the validating module 105 will not validate the new identity card 31 of the electronic device 20, and the locking module 103 can still lock the electronic device 20. Thus, no user can obtain information stored in the electronic device 20.

In order to use the electronic device 20, the electronic device 20 must be connected to the locking device 10. Then, the locking device 10 obtains identification information of the new identity card 31 arranged in the electronic device 20, and restores the identification information of the new identity card 31 to the second storage device 21. Thereby, the identity information read by the reading module 104 is same as the new identity information stored in the second storage device 21 and the validating module 105 validates the new identity card 31. The unlocking module 107 can thus unlock the electronic device 20 and allow the electronic device 20 to be used or re-used by user.

Referring to FIG. 1, the locking device 10 also includes an indicator light 14 and a press button 15. When an identity card is arranged in the electronic device 20, the first processor 12 can control the indicator light 14 to light, which reminds a user to match the identification information of the identity card with the identity information of the electronic device 20. The obtaining module 108 obtains the identification information of the identity card when the press button 15 is pressed.

The locking device 10 further includes a display device 16 to display location information of the electronic device 20. The electronic device 20 includes a location device (such as a GPS device) for obtaining the location information of the electronic device 20. The location device can transmit the location to a server. The locking device 10 can connect to the server via the communication device 13. The first processor 12 can get the location of the electronic device 20 from the server and control the display unit 16 to display the same.

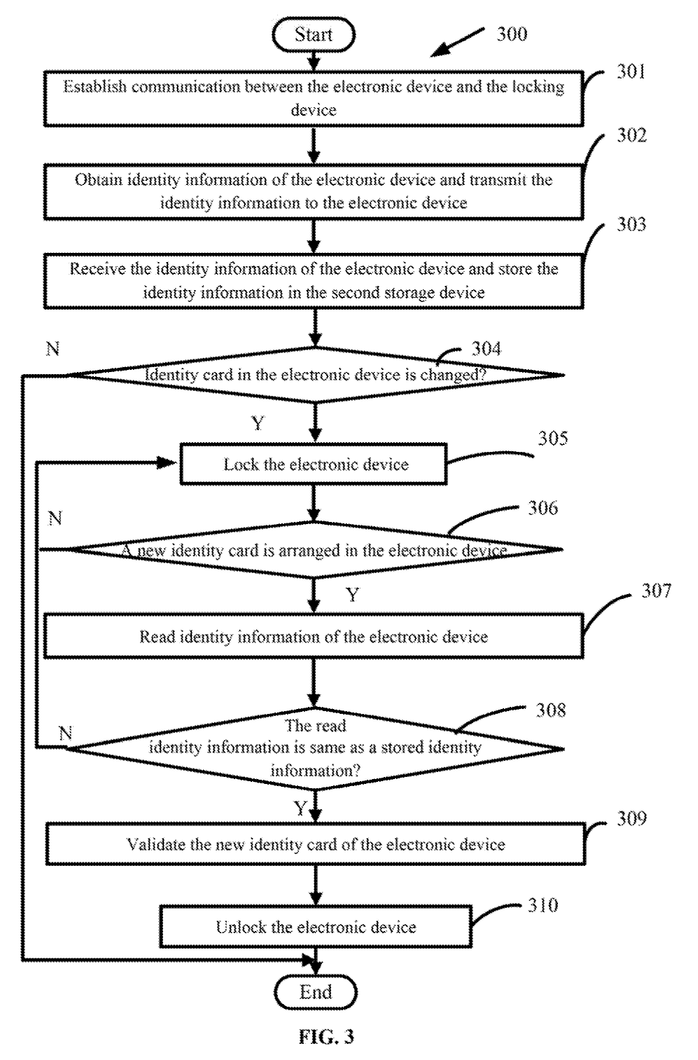

FIG. 3 is a flowchart of one embodiment of an unlocking method. The example method 300 is provided by way of example, as there are a variety of ways to carry out the method. The method 300 described below can be carried out using the configurations illustrated in FIGS. 1 and 2, for example, and various elements of these figures are referenced in explaining example method 300. Each block shown in FIG. 3 represents one or more processes, methods, or subroutines, carried out in the exemplary method 300. Additionally, the illustrated order of blocks is by example only and the order of the blocks can change. The exemplary method 300 can begin at block 301. Depending on the embodiment, additional steps can be added, others removed, and the ordering of the steps can be changed.

At block 301, the communication device establishes communication between the electronic device and the locking device.

At block 302, the obtaining module obtains identity information of the electronic device, and the transmitting module transmits the identity information to the electronic device.

In the embodiment, the identity information of the electronic device is associated with identification information within an identity card arranged in the electronic device. In an embodiment, the electronic device is a mobile phone. The identity card is a SIM card of the mobile phone. The identity information is the identification information of the identity card. In other embodiment, the identity information comprises several types of information, consisting of a card number, a telephone number, communication data, and PIN unlocking key

At block 303, the receiving module receives the identity information of the electronic device transmitted from the transmitting module, and stores the received identity information in the second storage device of the electronic device.

At block 304, the determining module determines whether the identity card arranged in the electronic device is changed. If yes, the process goes to block 305; if no, the process goes to end.

In the embodiment, the determining module 102 determines whether the reading module 104 can immediately read identity information from the electronic device. When the reading module 104 cannot immediately read the identity information from the electronic device for a predefined time, such as 10 seconds, then the determining module 102 determines that the identity card of the electronic device 20 is changed. That is, a user of the electronic device changes the identity card of the electronic device 20.

At block 305, the locking module locks the electronic device.

At block 306, the determining module determines whether a new identity card is arranged in the electronic device. If yes, the process goes to block 307, otherwise, the process goes back to block 305.

At block 307, the reading module reads identity information of the electronic device when a new identity card is arranged in the electronic device. The identity information of the electronic device is the identification information of the new identity card.

At block 308, the determining module determines whether the read identity information is same as a stored identity information. If yes, the process goes to block 309; if no, the process goes back to block 305.

At block 309, the validating module validates the new identity card of the electronic device.

At block 310, the unlocking module unlocks the electronic device.

The embodiments shown and described above are only examples. Many details are often found in the art and many such details are therefore neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for unlocking an electronic device being executed by at least one processor of the electronic device, the method comprising:
establishing communication between the electronic device and a locking device, wherein the locking device obtains identity information of the electronic device, the identity information of the electronic device is associated with identification information of an identity card arranged in the electronic device;
receiving the identity information transmitted from the locking device;
storing the received identity information in a storage device of the electronic device;
determining whether the identity card of the electronic device is changed;
locking the electronic device when the identity card of the electronic device is determined to be changed;
determining whether a new identity card is arranged in the electronic device;
reading identification information of the new identity card when the new identity card is determined to be arranged in the electronic device;
determining whether the read identification information is same as the identity information stored in the storage device;
validating the new identity card of the electronic device when the identification information is same as the identity information stored in the storage device; and
unlocking the electronic device.

2. The method according to claim 1, further comprising:
failing to validate the new identity card when the read identification information is not same as the identity information stored in the storage device; and
still locking the electronic device.

3. The method according to claim 1, wherein before the step “storing the received identity information in a storage device of the electronic device”, the method further comprising:
determining whether there is an identity information pre-stored in the storage device of the electronic device;
determining, when the identity information is pre-stored in the storage device, whether the received identity information is same as the pre-stored identity information; and
deleting the pre-stored identity information in the storage device when the received identity information is not same as the pre-stored identity information.

4. The method according to claim 1, wherein the identity card is a SIM card

5. The method according to claim 4, wherein the identity information comprises information selection from one element consisting of a card number, a telephone number, communication data, and pin unlocking key.

6. The method according to claim 1, wherein the step “determining whether the identity card of the electronic device is changed” further comprises:
determining whether the identity information of the electronic device is always read; and
determining the identity card of the electronic device is changed when the identity information of the electronic device is not read for a predefined time.

7. An electronic device, comprising:
at least one processor; and
a storage device that stores one or more programs which, when executed by the at least one processor, cause the at least one processor to:
establish a communication connect between the electronic device and a locking device, wherein the locking device obtains identity information of the electronic device, the identity information of the electronic device is associated with identification information of an identity card arranged in the electronic device;
receive the identity information transmitted from the locking device;
store the identity information received from the locking device in a storage device of the electronic device;
determine whether the identity card of the electronic device is changed;
lock the electronic device when the identity card of the electronic device is changed;
determine whether a new identity card is arranged in the electronic device;
read identification information of the new identity card when the new identity card is determined to be arranged in the electronic device;
determine whether the read identification information is same as the identity information stored in the storage device;
validate the new identity card of the electronic device when the read identification information is same as the identity information stored in the storage device; and
unlock the electronic device.

8. The electronic device according to claim 7, wherein the new identity card of the electronic device fails to be validated when the read identification information is not same as the identity information stored in the storage device; and the electronic device is till locked.

9. The electronic device according to claim 8, wherein before “store the identity information received from the locking device in a storage device of the electronic device”, the at least one processor is further caused to:
determine whether there is an identity information pre-stored in the storage device of the electronic device;
determine, when the identity information is pre-stored in the storage device, whether the received identity information is same as the pre-stored identity information; and
delete the pre-stored identity information in the storage device when the received identity information is not same as the pre-stored identity information.

10. The electronic device according to claim 7, wherein the electronic device is a mobile device, and the identity card is a SIM card.

11. The electronic device according to claim 10, wherein the identity information comprises information selection from one element consisting of a card number, a telephone number, communication data, and pin unlocking key.

12. The electronic device according to claim 7, wherein in order to “determine whether the identity card of the electronic device is changed”, the at least one processor is further caused to:
determine whether the identity information of the electronic device is always read; and
determine the identity card of the electronic device is changed when the identity information of the electronic device is not read for a predefined time.

13. A non-transitory storage medium having stored thereon instructions that, when executed by a processor of an electronic device, causes the processor to perform a method for unlocking the electronic device, wherein the method comprises:
establishing a communication connect between the electronic device and a locking device, wherein the locking device obtains identity information of the electronic device, the identity information of the electronic device is associated with identification information of an identity card arranged in the electronic device;
receiving the identity information transmitted from the locking device;
storing the received identity information in a storage device of the electronic device;
determining whether the identity card of the electronic device is changed;
locking the electronic device when the identity card of the electronic device is determined to be changed;
determining whether a new identity card is arranged in the electronic device;
reading identification information of the new identity card when the new identity card is determined to be arranged in the electronic device;
determining whether the read identification information is same as the identity information stored in the storage device;
validating the new identity card of the electronic device when the identification information is same as the identity information stored in the storage device; and
unlocking the electronic device.

14. The non-transitory storage medium according to claim 13, further comprising
failing to validate the new identity card when the read identification information is not same as the identity information stored in the storage device; and
still locking the electronic device.

15. The non-transitory storage medium according to claim 13, wherein before the step “storing the identity information received from the locking device in a storage device of the electronic device”, the method further comprising:
determining whether there is an identity information pre-stored in the storage device of the electronic device;
determining, when the identity information is pre-stored in the storage device, whether the received identity information is same as the pre-stored identity information; and
deleting the pre-stored identity information in the storage device when the received identity information is not same as the pre-stored identity information.

16. The non-transitory storage medium according to claim 13, wherein the identity card is a SIM card.

17. The non-transitory storage medium according to claim 16, wherein identity information comprises information selection from one element consisting of a card number, a telephone number, communication data, and pin unlocking key.

18. The non-transitory storage medium according to claim 13, wherein the step “determining whether the identity card of the electronic device is changed” further comprises:
determining whether the identity information of the electronic device is always read; and
determining the identity card of the electronic device is changed when the identity information of the electronic device is not read for a predefined time.
